(19) United States
(12) Patent Application Publication
(10) Pub. No.: US 2004/0153591 A1
(43) Pub. Date: Aug. 5, 2004

(54) Bus arbiter

(76) Inventors: Yoshiteru Tanaka, Kasuya-Gun (JP); Youichi Nishida, Kasuya-Gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/750,824

(22) Filed: Jan. 5, 2004

(30) Foreign Application Priority Data
Jan. 7, 2003 (JP) 2003-000818

(51) Int. Cl. G06F 13/00

(52) U.S. Cl. 710/107

(57) ABSTRACT

A slot allotment period register stores a slot allotment period specified in terms of the predetermined number of slots. A reserved-slot register stores a reserved-slot-number allotted in advance to VCE which performs a real-time processing. The reserved-slot register also stores a reserved-slot number allotted in advance to ACE which performs a real-time processing. A remaining-reserved-slot register stores the result of subtracting the reserved-slot numbers of the VCE and the ACE from the slot allotment period. It is possible to judge beforehand whether the processing to be performed will fail or not due to the shortage of slot number, by externally monitoring the remaining-reserved-slot register.

### BACKGROUND OF THE INVENTION

1. Field of the Invention

The present invention relates to a bus arbiter, which performs arbitration between two or more modules connected to a bus.

2. Description of the Related Art

Typified by the introduction of the third generation cellular phone, recent advancement of cellular phones demands a system that may practice a plurality of real-time processing of moving picture and audio and unreal-time processing of mail and others.

Such a system comprises a plurality of modules connected to a bus, and a bus arbiter that arbitrates data transfer between the modules.

Each of the modules is hardware that executes processing. One of the modules connected to the bus is a processor.

Real-time processing is processing with a time limit for executing a determined processing. On the other hand, unreal-time processing is processing without time limit.

The system, which practices both of the real-time processing and the unreal-time processing, comprises a module that performs the real-time processing (hereinafter called a “real-time module”) and a module that performs the unreal-time processing (hereinafter called an “unreal-time module”).

In order to perform the processing within a time limit, the real-time module needs to transfer data required for the processing within the time limit.

In the system that practices both of the real-time processing and the unreal-time processing, a bus is a time-common resource that is commonly used in both of the processing; while a memory resource etc. is a spatial-common resource.

Therefore, when the unreal-time module has used up slot number, the real-time module can not transfer data required for processing from a memory, even though the real-time module can secure the memory resource. As a result, the processing can not be performed within the time limit.

Accordingly, control for securing a bus bandwidth (i.e. the slot number) has been performed by introducing a bus arbiter, which arbitrates a data transfer request from a module.

For example, reference 1 (Japanese translation of PCT international application No. 2000-500895) has proposed a bus arbiter that performs weighted bandwidth allotment.

The bus arbiter secures each of the modules a necessary bus bandwidth by assigning each of the modules a time slot that is weighted in order to allot the bus bandwidth.

Thereby, the real-time module can perform the real-time processing of a moving picture and audio, using the bus bandwidth that is allotted beforehand.

For example, it is assumed that a request is made to a module to expand a screen size for a moving picture that should be processed, from QCIF (176 pixels×144 pixels) to CIF (352 pixels×288 pixels). The module performs compression/expansion for a moving picture such as MPEG-4 (Moving Picture Experts Group 4).

In this case, the amount of data that the module must process within the time limit will increase. The increased data will not be able to be processed under the arbitration by the conventional bus arbiter, since the module performs the processing within the bus bandwidth that is allotted beforehand.

Therefore, the module can not complete processing within the time limit, and it causes failure in a nature of real-time.

### OBJECTS AND SUMMARY OF THE INVENTION

An object of the present invention is to provide a bus arbiter that can determine beforehand whether or not processing will fail due to shortage of bus bandwidth (i.e. a number of slots).

A first aspect of the present invention provides a bus arbiter operable to arbitrate data transfer requests among plural modules connected to a bus. The bus arbiter comprises: a slot allotment period storing unit, a reserved-slot-number storing unit, a remaining-reserved-slot-number storing unit, a remaining-slot-number calculating unit, a first renewed-slot-number storing unit, a second renewed-slot-number storing unit, a plurality of renewed-slot-number-designating storing units, a transfer-permissible-candidate determining unit, and a transfer permission determining unit.

The slot allotment period storing unit is operable to store information of a slot allotment period including plural slots.

The reserved-slot-number storing unit is operable to store information of a reserved slot number, the reserved slot number being a slot number previously allotted to a predetermined module of the plural modules.

The remaining-reserved-slot-number storing unit is operable to store information of a remaining reserved slot number, the remaining reserved slot number being a difference between a total slot number constituting the slot allotment period and the reserved slot number.

The remaining-slot-number calculating unit is operable to calculate a remaining slot number of the reserved slot number each time when a data transfer request is permitted for the predetermined module to which the reserved slot number is allotted. The remaining-slot-number calculating unit is also operable to calculate a remaining slot number of the remaining reserved slot number each time when a data transfer request is permitted for the module that uses the remaining reserved slot number.

The first renewed-slot-number storing unit is operable to store, as an initial value, information of the reserved slot number stored in the reserved-slot-number storing unit, and also operable to store information of the remaining slot number of the reserved slot number, the remaining slot number being calculated by the remaining-slot-number calculating unit.

The second renewed-slot-number storing unit is operable to store, as an initial value, information of the remaining reserved slot number stored in the remaining-reserved-slot-number storing unit, and also operable to store information of the remaining slot number of the remaining reserved slot number, the remaining slot number being calculated by the remaining-slot-number calculating unit.

The plurality of renewed-slot-number-designating storing units are operable to store information designating the first renewed-slot-number storing unit or the second renewed-slot-number storing unit, each thereof being installed corresponding to the plural modules and allotted to the corresponding module.

The transfer-permissible-candidate determining unit is operable, in response to a request of data transfer from the module, to generate a transfer-permissible-candidate notifying signal indicating that the module is a candidate for which a data transfer request is permitted only when, referring to either the first renewed-slot-number storing unit or the second renewed-slot-number storing unit designated by the information stored in the renewed-slot-number-designating storing unit that corresponds to the module, a remaining slot number still remains, the remaining slot number being stored in either the first renewed-slot-number storing unit or the second renewed-slot-number storing unit that is referred.

The transfer permission determining unit is operable, according to a predetermined rule, to determine permission for the data transfer request from the module designated by the transfer-permissible-candidate notifying signal.

Information indicating the first renewed-slot-number storing unit is stored in the renewed-slot-number-designating storing unit corresponding to the predetermined module to which the reserved slot number is allotted.

Information indicating the second renewed-slot-number storing unit is stored in the renewed-slot-number-designating storing unit corresponding to the predetermined module that uses the remaining reserved slot number.

Information of the reserved slot number stored in the reserved-slot-number storing unit is stored, as an initial value, into the first renewed-slot-number storing unit each time when the slot allotment period elapses.

Information of the remaining reserved slot number stored in the remaining-reserved-slot-number storing unit is stored, as an initial value, into the second renewed-slot-number storing unit each time when the slot allotment period elapses.

According to the construction described above, it can be determined beforehand whether processing to be executed from now on by the module will fail or not because of the shortage of the bus bandwidth, by externally monitoring the remaining reserved slot number stored in the remaining-reserved-slot-number storing unit.

The slot allotment period can be changed by externally changing a setup of the slot allotment period storing unit. Furthermore, the reserved slot number can be changed by externally changing a setup of the reserved-slot-number storing unit. Consequently, the user's convenience can be improved.

A second aspect of the present invention provides a bus arbiter, as defined in the first aspect of the present invention, wherein plural pieces of the predetermined module are connected to the bus; plural pieces of the reserved-slot-number storing unit are provided corresponding to the plural pieces of the predetermined module; and plural pieces of the first renewed-slot-number storing unit are provided corresponding to the plural pieces of the reserved-slot-number storing unit.

According to the construction described above, more modules can reserve the slot number beforehand.

A third aspect of the present invention provides a bus arbiter, as defined in the first aspect of the present invention, wherein, when the remaining slot number of the reserved slot number is exhausted, the remaining-slot-number calculating unit notifies a manager-assigned module of the plural modules that the predetermined module, to which the reserved slot number is allotted, has spent all the reserved slot number.

According to the construction described above, a useless data transfer request can be prevented.

A fourth aspect of the present invention provides a bus arbiter operable to arbitrate data transfer requests among plural tasks managed by a task manager connected to a bus. The bus arbiter comprises: a slot allotment period storing unit, a reserved-slot-number storing unit, a remaining-reserved-slot-number storing unit, a remaining-slot-number calculating unit, a first renewed-slot-number storing unit, a second renewed-slot-number storing unit, a plurality of renewed-slot-number-designating storing units, a transfer-permissible-candidate determining unit, and a transfer permission determining unit.

The slot allotment period storing unit is operable to store information of a slot allotment period including plural slots.

The reserved-slot-number storing unit is operable to store information of a reserved slot number, the reserved slot number being a slot number previously allotted to a predetermined task of the plural tasks.

The remaining-reserved-slot-number storing unit is operable to store information of a remaining reserved slot number, the remaining reserved slot number being a difference between a total slot number constituting the slot allotment period and the reserved slot number.

The remaining-slot-number calculating unit is operable to calculate a remaining slot number of the reserved slot number each time when a data transfer request is permitted for the predetermined task to which the reserved slot number is allotted. The remaining-slot-number calculating unit is also operable to calculate a remaining slot number of the remaining reserved slot number each time when a data transfer request is permitted for the task that uses the remaining reserved slot number.

The first renewed-slot-number storing unit is operable to store, as an initial value, information of the reserved slot number stored in the reserved-slot-number storing unit, and also operable to store information of the remaining slot number of the reserved slot number, the remaining slot number being calculated by the remaining-slot-number calculating unit.

The second renewed-slot-number storing unit is operable to store, as an initial value, information of the remaining reserved slot number stored in the remaining-reserved-slot-number storing unit, and also operable to store information of the remaining slot number of the remaining reserved slot number, the remaining slot number being calculated by the remaining-slot-number calculating unit.

The plurality of renewed-slot-number-designating storing units are operable to store information designating the first renewed-slot-number storing unit or the second renewed-slot-number storing unit, each thereof being installed corresponding to the plural tasks and allotted to the corresponding task.

The transfer-permissible-candidate determining unit is operable, in response to a request of data transfer from the task, to generate a transfer-permissible-candidate notifying signal indicating that the task is a candidate for which a data transfer request is permitted only when, referring to either the first renewed-slot-number storing unit or the second renewed-slot-number storing unit designated by the information stored in the renewed-slot-number-designating storing unit that corresponds to the task, a remaining slot number still remains, the remaining slot number being stored in either the first renewed-slot-number storing unit or the second renewed-slot-number storing unit that is referred.

The transfer permission determining unit is operable, according to a predetermined rule, to determine permission for the data transfer request from the module designated by the transfer-permissible-candidate notifying signal.

Information indicating the first renewed-slot-number storing unit is stored in the renewed-slot-number-designating storing unit corresponding to the predetermined task to which the reserved slot number is allotted.

Information indicating the second renewed-slot-number storing unit is stored in the renewed-slot-number-designating storing unit corresponding to the predetermined task that uses the remaining reserved slot number.

Information of the reserved slot number stored in the reserved-slot-number storing unit is stored, as an initial value, into the first renewed-slot-number storing unit each time when the slot allotment period elapses.

Information of the remaining reserved slot number stored in the remaining-reserved-slot-number storing unit is stored, as an initial value, into the second renewed-slot-number storing unit each time when the slot allotment period elapses.

According to the construction described above, it can be determined beforehand whether processing to be executed from now on by the task will fail or not because of the shortage of the bus bandwidth, by externally monitoring the remaining reserved slot number stored in the remaining-reserved-slot-number storing unit.

The slot allotment period can be changed by externally changing a setup of the slot allotment period storing unit. Furthermore, the reserved slot number can be changed by externally changing a setup of the reserved-slot-number storing unit. Consequently, the user's convenience can be improved.

A fifth aspect of the present invention provides a bus arbiter, as defined in the fourth aspect of the present invention, wherein plural pieces of the predetermined task are present; plural pieces of the reserved-slot-number storing unit are provided corresponding to the plural pieces of the predetermined task; and plural pieces of the first renewed-slot-number storing unit are provided corresponding to the plural pieces of the reserved-slot-number storing unit.

According to the construction described above, more tasks can reserve the slot number beforehand.

A sixth aspect of the present invention provides a bus arbiter, as defined in the fourth aspect of the present invention, wherein, when the remaining slot number of the reserved slot number is exhausted, the remaining-slot-number calculating unit notifies the task manager that the predetermined task, to which the reserved slot number is allotted, has spent all the reserved slot number.

According to the construction described above, a useless data transfer request can be prevented.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram, illustrating a data processing apparatus according to a first embodiment of the present invention;

FIG. 2 is a block diagram, illustrating a bus arbiter according to the first embodiment of the present invention;

FIG. 3 is an explanatory diagram, illustrating a reserved-slot table according to the first embodiment of the present invention;

FIG. 4 is an explanatory diagram, illustrating a renewed-slot designating table according to the first embodiment of the present invention;

FIG. 5 is an explanatory diagram, illustrating a priority table according to the first embodiment of the present invention;

FIG. 6 is a time chart, illustrating how the bus arbiter executes the processing according to the first embodiment of the present invention;

FIG. 7 is a flowchart, illustrating operation of the bus arbiter according to the first embodiment of the present invention.

FIG. 8 is a block diagram, illustrating a data processing apparatus according to a second embodiment of the present invention.

### DETAILED DESCRIPTION OF THE PREFERRED EMBODIMENTS

Hereinafter, referring to the drawings, embodiments of the present invention will be explained.

### EMBODIMENT 1

FIG. 1 is a block diagram illustrating a data processing apparatus according to a first embodiment of the present invention.

As shown in FIG. 1, the data processing apparatus possesses a bus arbiter 1, a CPU (Central Processing Unit) 2, a VCE (Video Codec Engine) 3, an ACE (Audio Codec Engine) 4, a PCE (Picture Codec Engine) 5, and a memory 6.

The bus arbiter 1, the CPU 2, the VCE 3, the ACE 4 and the PCE 5, and the memory 6 are connected each other via a bus 8.

Moreover, the bus arbiter 1, the CPU 2, the VCE 3, the ACE 4, the PCE 5, and the memory 6 are connected each other via a data transfer control line 7.

The CPU 2 is connected to the bus arbiter 1 by an interruption signal line 9 from the bus arbiter 1.

Each of the CPU 2, the VCE 3, the ACE 4, and the PCE 5 may be called a module.

The bus arbiter 1 is an apparatus which allots a data transfer per slot to each module upon receiving the data transfer request from modules such as the CPU 2, the VCE 3, the ACE 4, and the PCE 5.

In addition, the bus arbiter 1 possesses a mechanism that can reserve a slot number to each module, and a mechanism that can monitor a remaining reserved-slot-number.

The bus arbiter 1 assumes that one slot is a predetermined bus cycle number (a predetermined bus clock number).

The CPU 2 is a module which executes a program.

The memory 6 stores data.

The VCE 3 is a moving picture processing module which performs moving picture compression/expansion processing, based on an MPEG (Moving Picture Experts Group) and other methods, for image data that is stored in the memory 6, and re-writes the processed image data to the memory 6.

The ACE 4 is an audio processing module which performs audio data compression/expansion processing, based on an AMR (Audio/Modem Riser) and other methods, for audio data that is stored in the memory 6, and re-writes the processed audio data to the memory 6.

The PCE 5 is a still picture processing module which performs still picture compression/expansion processing, based on JPEG (Joint Photographic Experts Group) and other methods, for still picture data that is stored in the memory 6, and re-writes the processed still picture data to the memory 6.

The data processing apparatus shown in FIG. 1 realizes functions that perform several kinds of compression/expansion for moving picture data, audio data, and still picture data.

In the case of FIG. 1, since the compression/expansion processing of a moving picture and audio is a real-time processing, the bus arbiter 1 possesses a mechanism that allots a number of slots required for the real-time processing to the VCE 3, which is the moving picture processing module, and the ACE 4, which is the audio processing module.

Next, the bus arbiter 1 will be explained in details.

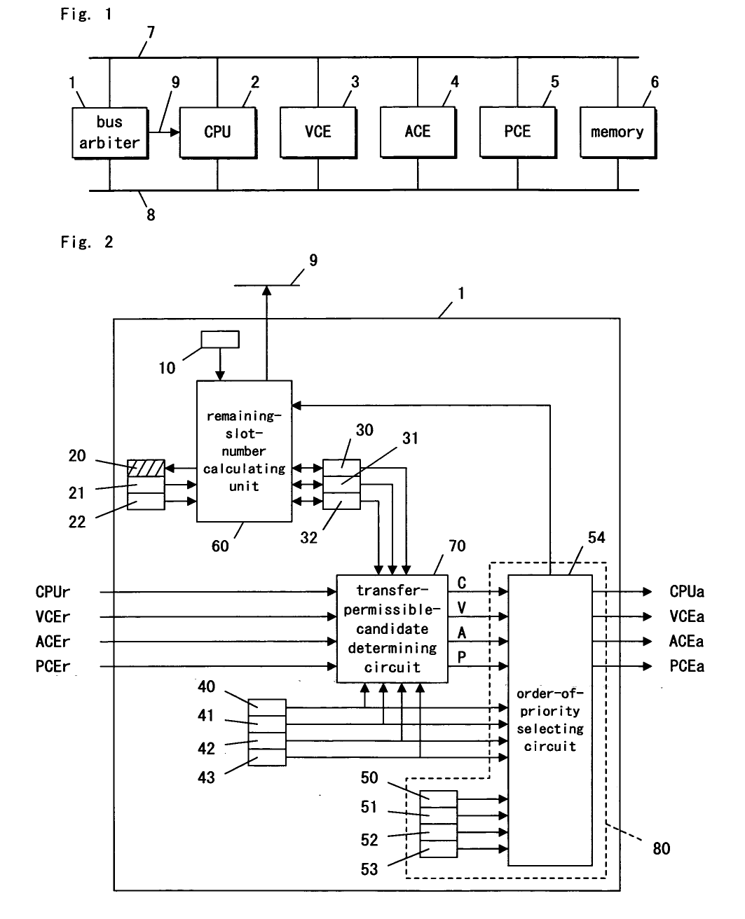

FIG. 2 is a block diagram of the bus arbiter 1 illustrated in FIG. 1. In FIG. 2, the same symbols are attached to the parts, which are similar as in FIG. 1

As shown in FIG. 2, the bus arbiter 1 includes a slot allotment period register 10, a remaining-reserved-slot register 20, reserved-slot registers 21 and 22, renewed-slot registers 30, 31, and 32, renewed-slot designating registers 40, 41, 42, and 43, a remaining-slot-number calculating circuit 60, a transfer-permissible-candidate determining circuit 70, and a transfer permission determining circuit 80.

The transfer permission determining circuit 80 includes priority registers 50, 51, 52, and 53 and an order-of-priority selecting circuit 54.

The slot allotment period register 10 is a register which stores information indicating the slot allotment period specified in terms of the predetermined number of slots.

The slot allotment period for the slot allotment period register 10 can be set externally. For example, the CPU 2 can set the slot allotment period to the slot allotment period register 10.

A predetermined slot-number is beforehand allotted to each of the VCE 3 and the ACE 4, which perform real-time processing. In this case, the number of slots allotted beforehand is called a reserved-slot-number.

The reserved-slot register 21 stores information indicating the reserved-slot-number allotted to VCE 3.

The reserved-slot-number of the VCE 3 for the reserved-slot register 21 can be set externally. For example, the CPU 2 can set the reserved-slot-number of the VCE 3 to the reserved-slot register 21.

The reserved-slot register 22 stores information indicating the reserved-slot-number allotted to the ACE 4.

The reserved-slot-number of the ACE 4 for the reserved-slot register 22 can be set externally. For example, the CPU 2 can set the reserved-slot-number of the ACE 4 to the reserved-slot register 22.

The remaining-reserved-slot register 20 stores information indicating a value obtained by subtracting the reserved-slot-number stored in the reserved-slot register 21 and the reserved-slot-number stored in the reserved-slot register 22 from the slot-number that composes the slot allotment period. The value is hereinafter called a “remaining reserved-slot-number”.

The remaining reserved-slot-number is used by the CPU 2 and the PCE 5.

The reserved-slot registers 21 and 22 and the remaining-reserved-slot register 20 constitute a reservation slot table.

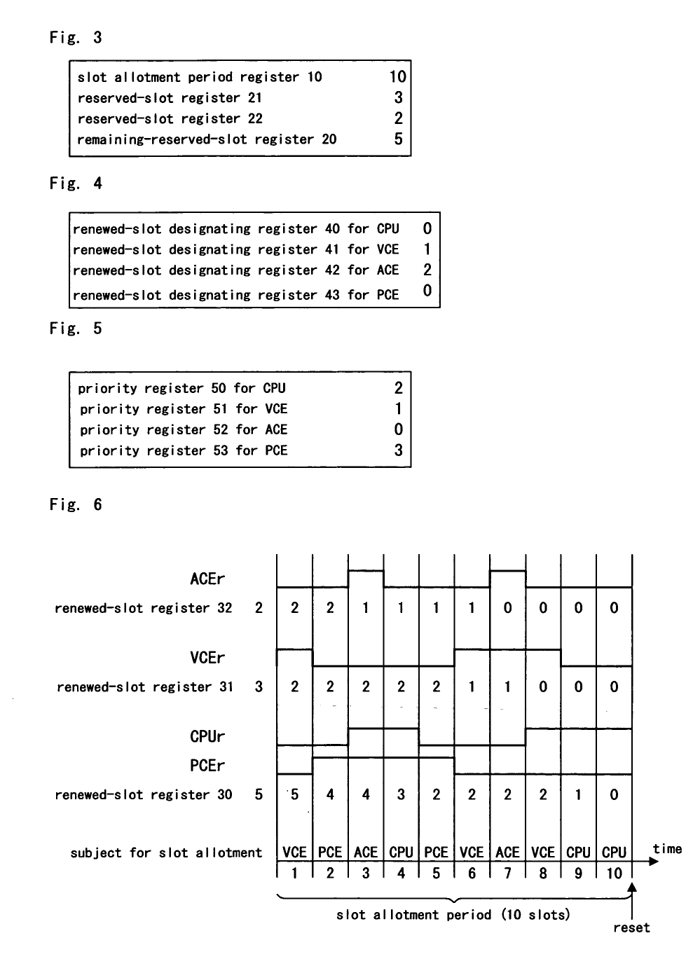

FIG. 3 is an explanatory diagram of the reservation slot table. In the example of FIG. 3, the number of slots that constitutes the slot allotment period stored in the slot allotment period register 10 is ten (10) slots.

In the example of FIG. 3, the reserved-slot-number of the VCE 3 stored in the reserved-slot register 21 is three (3) slots.

In the example of FIG. 3, the reserved-slot-number of the ACE 4 stored in the reserved-slot register 22 is two (2) slots.

In the example of FIG. 3, the remaining reserved-slot-number stored in the remaining-reserved-slot register 20 is five (5) slots. The umber is 5 because 10−(3+2)=5.

The remaining-slot-number calculating circuit 60 calculates a remaining reserved-slot-number by subtracting the reserved-slot-number stored in the reserved-slot register 21 and the reserved-slot-number stored in the reserved-slot register 22 from the number of slots that composes the slot allotment period.

The remaining reserved-slot-number stored in the remaining-reserved-slot register 20 is calculated by the remaining-slot-number calculating circuit 60.

The renewed-slot register 31 stores, as the initial value (reset value), information which indicates the reserved-slot-number of the VCE 3, the reserved-slot-number being stored in the reserved-slot register 21.

When the data transfer request of the VCE 3 is permitted, the remaining-slot-number calculating circuit 60 calculates the remaining-slot-number of the reserved-slot number by subtracting one slot from the reserved-slot-number that is allotted to the VCE 3 and stored in the renewed-slot register 31.

The remaining-slot-number calculating circuit 60 overwrites information indicating the remaining-slot-number into the renewed-slot register 31.

Furthermore, every time when the data transfer request of the VCE 3 is permitted, the remaining-slot-number calculating circuit 60 calculates the remaining-slot-number of the reserved-slot number for the VCE 3 by subtracting one slot from the remaining-slot-number of the reserved-slot-number that is stored in the renewed-slot-register 31. The remaining-slot-number calculating circuit 60 overwrites the calculated result into the renewed-slot register 31.

In this manner, the reserved-slot-number of the VCE 3 is counted down.

The renewed-slot register 32 stores, as the initial value (reset value), information which indicates the reserved-slot-number of the ACE 4, the reserved-slot-number being stored in the reserved-slot register 22.

When the data transfer request of the ACE 4 is permitted, the remaining-slot-number calculating circuit 60 calculates the remaining-slot-number of the reserved-slot number by subtracting one slot from the reserved-slot-number that is allotted to the ACE 4 and stored in the renewed-slot register 32.

The remaining-slot-number calculating circuit 60 overwrites information indicating the remaining-slot-number into the renewed-slot register 32.

Furthermore, every time when the data transfer request of the ACE 4 is permitted, the remaining-slot-number calculating circuit 60 calculates the remaining-slot-number of the reserved-slot number for the ACE 4 by subtracting one slot from the remaining-slot-number of the reserved-slot-number that is stored in the renewed-slot register 32. The remaining-slot-number calculating circuit 60 overwrites the calculated result into the renewed-slot register 32.

In this manner, the reserved-slot-number of the ACE 4 is counted down.

The renewed-slot register 30 stores, as the initial value (reset value), information which indicates the remaining reserved-slot-number stored in the remaining-reserved-slot register 20.

When the data transfer request of the CPU 2 or the PCE 5 is permitted, the remaining-slot-number calculating circuit 60 calculates the remaining-slot-number of the remaining reserved-slot number by subtracting one slot from the remaining reserved-slot-number that is stored in the renewed-slot register 30.

The remaining-slot-number calculating circuit 60 overwrites information indicating the remaining-slot-number into the renewed-slot register 30.

Furthermore, every time when the data transfer request of the CPU 2 or the PCE 5 is permitted, the remaining-slot-number calculating circuit 60 calculates the remaining-slot-number of the remaining reserved-slot number by subtracting one slot from the remaining-slot-number of the remaining reserved-slot-number that is stored in the renewed-slot register 30. The remaining-slot-number calculating circuit 60 overwrites the calculated result into the renewed-slot register 30.

In this manner, the remaining reserved-slot-number is counted down.

When the slot allotment period, which is designated by the slot allotment period register 10, has passed, the renewed-slot registers 30, 31, and 32 are reset.

In other words, when the slot allotment period, which is designated by the slot allotment period register 10, has passes, the remaining-slot-number calculating circuit 60 writes, as the initial value (reset value), information indicating the reserved-slot-number stored in the reserved-slot register 21 into the renewed-slot register 31. The remaining-slot-number calculating circuit 60 also writes, as the initial value (reset value), information indicating the reserved-slot-number stored in the reserved-slot register 22 to the renewed-slot register 32. The remaining-slot-number calculating circuit 60 also writes, as the initial value (reset value), information indicating the remaining reserved-slot-number stored in the remaining-reserved-slot register 20 into the renewed-slot register 30.

Then, the countdown of the reserved-slot-number and the remaining reserved-slot-number is executed again.

Thus, reset and countdown are performed repeatedly. When the slot allotment period passes, reset will be performed even when the countdown value is not “0”.

The renewed-slot designating registers 40 to 43 are provided, corresponding to the CPU 2, the VCE 3, the ACE 4, and the PCE 5, respectively.

Then, designating information for the CPU 2, designating information for the VCE 3, designating information for the ACE 4, and designating information for the PCE 5 are stored in the renewed-slot designating registers 40, 41, 42, and 43, respectively.

The designating information is information designating the renewed-slot register 31, information designating the renewed-slot register 32 or information designating the renewed-slot register 30.

Specifically, the information designating the renewed-slot register 30 is stored in the renewed-slot designating register 40 as the designating information for the CPU 2, because the CPU 2 consumes the remaining reserved-slot-number stored in the remaining-reserved-slot register 20.

The information designating the renewed-slot register 31 is stored in the renewed-slot designating register 41 as the designating information for the VCE 3, because the VCE 3 consumes the reserved-slot-number stored in the reserved-slot register 21.

The information designating the renewed-slot register 32 is stored in the renewed-slot designating register 42 as the designating information for the ACE 4, because the ACE 4 consumes the reserved-slot-number stored in the renewed-slot designating register 43.

The information designating the renewed-slot register 30 is stored in the renewed-slot designating register 43 as the designating information for the PCE 5, because the PCE 5 consumes the remaining reserved-slot-number stored in the remaining-reserved-slot register 20.

The designating information of the renewed-slot designating registers 40-43 can be set up externally, for example by the CPU 2.

In addition, when initial setting of the bus arbiter 1 is performed, information designating the renewed-slot register 30 is stored in all of the renewed-slot designating registers 40-43. Then, information designating the renewed-slot registers 31 and 32 is overwritten externally to the desired renewed-slot designating register.

The renewed-slot designating registers 40-43 compose a renewed-slot designating table.

FIG. 4 is an explanatory diagram, illustrating the renewed-slot designating table.

In the example of FIG. 4, a value “0” designating the renewed-slot register 30 is stored in the renewed-slot designating register 40 corresponding to the CPU 2. A value “1” designating the renewed-slot register 31 is stored in the renewed-slot designating register 41 corresponding to the VCE 3. A value “2” indicating the renewed-slot register 32 is stored in the renewed-slot designating register 42 corresponding to the ACE 4. A value “0” indicating the renewed-slot register 30 is stored in the renewed-slot designating register 43 corresponding to the PCE 5.

In the example of FIG. 4, the CPU 2 and the PCE 5 share the renewed-slot register 30.

Via the data transfer control line 7, the transfer-permissible-candidate determining circuit 70 receives a data transfer request signal CPUr from the CPU 2, a data transfer request signal VCEr from the VCE 3, a data transfer request signal ACEr from the ACE 4, and a data transfer request signal PCEr from the PCE 5.

When the transfer-permissible-candidate determining circuit 70 receives the data transfer request signal CPUr from the CPU 2, the transfer-permissible-candidate determining circuit 70 refers to the renewed-slot designating register 40 corresponding to the CPU 2.

Then, the transfer-permissible-candidate determining circuit 70 refers to the renewed-slot register 30 that is designated by the information stored in the renewed-slot designating register 40.

When the remaining slot-number (countdown value) of the remaining reserved-slot-number stored in the renewed-slot register 30 is not “0” the transfer-permissible-candidate determining circuit 70 outputs to the order-of-priority selecting circuit 54 a transfer-permissible-candidate notifying signal C, which indicates that the CPU 2 is a candidate to be permitted for the data transfer (a transfer permissible candidate).

When the transfer-permissible-candidate determining circuit 70 receives the data transfer request signal VCEr from the VCE 3, the transfer-permissible-candidate determining circuit 70 refers to the renewed-slot designating register 41 corresponding to the VCE 3.

Then, the transfer-permissible-candidate determining circuit 70 refers to the renewed-slot register 31 that is designated by the information stored in the renewed-slot designating register 41.

When the remaining slot-number (countdown value) of the reserved-slot-number stored in the renewed-slot register 31 is not “0”, the transfer-permissible-candidate determining circuit 70 outputs to the order-of-priority selecting circuit 54 a transfer-permissible-candidate notifying signal V, which indicates that the VCE 3 is a candidate to be permitted for the data transfer (a transfer permissible candidate).

When the transfer-permissible-candidate determining circuit 70 receives the data transfer request signal ACEr from the ACE 4, the transfer-permissible-candidate determining circuit 70 refers to the renewed-slot designating register 42 corresponding to the ACE 4.

Then, the transfer-permissible-candidate determining circuit 70 refers to the renewed-slot register 33 that is designated by the information stored in the renewed-slot designating register 42.

When the remaining slot-number (countdown value) of the reserved-slot-number stored in the renewed-slot register 32 is not “0”, the transfer-permissible-candidate determining circuit 70 outputs to the order-of-priority selecting circuit 54 a transfer-permissible-candidate notifying signal A, which indicates that the ACE 4 is a candidate to be permitted for the data transfer (a transfer permissible candidate).

When the transfer-permissible-candidate determining circuit 70 receives the data transfer request signal PCEr from the PCE 5, the transfer-permissible-candidate determining circuit 70 refers to the renewed-slot designating register 43 corresponding to the PCE 5.

Then, the transfer-permissible-candidate determining circuit 70 refers to the renewed-slot register 30 that is designated by the information stored in the renewed-slot designating register 43.

When the remaining slot-number (countdown value) of the reserved-slot-number stored in the renewed-slot register 30 is not “0”, the transfer-permissible-candidate determining circuit 70 outputs to the order-of-priority selecting circuit 54 a transfer-permissible-candidate notifying signal P, which indicates that the PCE 5 is a candidate to be permitted for the data transfer (a transfer permissible candidate).

The priority registers 50-53 are provided corresponding to the CPU 2, the VCE 3, the ACE 4, and the PCE 5, respectively.

Information indicating the priority of the CPU 2 is stored in the priority register 50. Information indicating the priority of the VCE 3 is stored in the priority register 51. Information indicating the priority of the ACE 4 is stored in the priority register 52. Information indicating the priority of the PCE 5 is stored in the priority register 53.

The priority can be set externally into the priority registers 50-53. For example, the CPU 2 can set the priority into the priority registers 50-53.

The priority registers 50-53 compose a priority table.

FIG. 5 is an explanatory diagram, illustrating the priority table.

In the example of FIG. 5, the priority table is set up so that the priority is in the order of the ACE 4>the VCE 3>the CPU 2>the PCE 5. In short, in the priority table of FIG. 5, the priority is higher when the setup number is smaller.

In a case where plural pieces of the transfer-permissible-candidate notifying signals are inputted from the transfer-permissible-candidate determining circuit 70, that is a case where plural modules are permitted as transfer permissible candidates, the order-of-priority selecting circuit 54 refers to the priority registers 50-53, and gives a transfer permission signal via the data transfer control line 7 to a transfer permissible candidate whose priority is highest among the plural transfer permissible candidates.

In FIG. 2, a transfer permission signal CPUa indicates a transfer permission signal to the CPU 2, a transfer permission signal VCEa indicates a transfer permission signal to the VCE 3, a transfer permission signal ACEa indicates a transfer permission signal to the ACE 4, and a transfer permission signal PCEa indicates a transfer permission signal to the PCE 5.

For example, in a case of the priority table as shown in FIG. 5, when the order-of-priority selecting circuit 54 receives the transfer-permissible-candidate notifying signal C and the transfer-permissible-candidate notifying signal V, the order-of-priority selecting circuit 54 gives the transfer permission signal PCEa to the VCE 3, since the VCE 3 possesses the higher priority.

On the other hand, the order-of-priority selecting circuit 54 refers to the renewed-slot designating register corresponding to the transfer permissible candidate that is already given the transfer permission signal.

Then, the order-of-priority selecting circuit 54 gives the remaining-slot-number calculating circuit 60 the information stored in the referred renewed-slot designating register.

The remaining-slot-number calculating circuit 60 selects one of the renewed-slot register 31, the renewed-slot register 32, and the renewed-slot register 30, based on the information that is given by the order-of-priority selecting circuit 54, and subtracts one slot from the remaining slot-number that is stored in the selected register.

The remaining-slot-number calculating circuit 60 overwrites information indicating the remaining slot-number, which has been calculated in the above-mentioned way, to one of the renewed-slot register 31, the renewed-slot register 32, and the renewed-slot register 30, based on the information that has been given by the order-of-priority selecting circuit 54.

Every time when transfer permission is given, the reserved-slot-number or the remaining reserved-slot-number of the transfer permissible candidate that is given the transfer permission is counted down.

It will be explained by exemplifying a case where the ACE 4 is the transfer permissible candidate to which the transfer permission has been given.

The order-of-priority selecting circuit 54 refers to the renewed-slot designating register 42 corresponding to the ACE 4.

Then, the order-of-priority selecting circuit 54 gives the information stored in the renewed-slot designating register 42 or the information indicating the renewed-slot register 32, to the remaining-slot-number calculating circuit 60.

The remaining-slot-number calculating circuit 60 subtracts one slot from the remaining slot-number of the reserved-slot-number for the ACE 4, the remaining slot-number being stored in a renewed-slot register designated by the information that is given by the order-of-priority selecting circuit 54.

The remaining-slot-number calculating circuit 60 overwrites information indicating the remaining slot-number of the ACE 4, which has been calculated in the above-mentioned way, to the renewed-slot register 32 designated by the information that is given by the order-of-priority selecting circuit 54.

In this example, the reserved-slot-number of the ACE 4 is counted down in the above-mentioned way.

When the remaining slot-number of the reserved-slot-number becomes “0” as a result of the countdown (as a result of subtraction) or when the remaining slot-number of the remaining reserved-slot-number becomes “0”, the remaining-slot-number calculating circuit 60 notifies the CPU 2 via the interruption signal line that the module, which uses the reserved-slot-number or the remaining reserved-slot-number with a “0” remaining slot-number, has used up the reserved-slot-number or the remaining reserved-slot-number.

In this case, the remaining-slot-number calculating circuit 60 can also notify the module that uses the reserved-slot-number or the remaining reserved-slot-number, whose remaining slot-number is “0”, that the reserved-slot-number or the remaining reserved-slot-number has been used up.

The operation of the bus arbiter 1 shown in FIG. 1 is explained in detail, using FIG. 2 and the time chart.

In this case, it is assumed that the reservation slot table includes the remaining-reserved-slot register 20 and the reserved-slot registers 21 and 22 of FIG. 2, and is set up as shown in FIG. 3. It is also assumed that the renewed-slot designating table includes the renewed-slot designating registers 40-43 of FIG. 2, and is set up as shown in FIG. 4. It is further assumed that the priority table includes priority registers 50-53 of FIG. 2, and is set up as shown in FIG. 5.

FIG. 6 is a time chart for explaining the operation of the bus arbiter 1.

As shown in FIG. 6, the slot number that composes the slot allotment period is ten slots, and the renewed-slot registers 30, 31, and 32 are reset every ten slots.

As shown in FIG. 6, at the time of reset, the remaining slot-number of the ACE 4 (the slot number stored in the renewed-slot register 32) is “2” as the initial value (reset value). At the time of reset, the remaining slot-number of the VCE 3 (the slot number stored in the renewed-slot register 31) is “3” as the initial value (reset value), and the remaining slot-numbers of the CPU 2 and the PCE 5 are “5” as the initial value (reset value).

As shown in FIG. 6, at the first slot of the slot allotment period, only the VCE 3 gives the data transfer request signal VCEr (a signal of level “H (high)”) to the transfer-permissible-candidate determining circuit 70.

The transfer-permissible-candidate determining ciruit 70 gives the transfer-permissible-candidate notifying signal V indicating that the transfer permissible candidate is the VCE 3 to the order-of-priority selecting circuit 54.

The order-of-priority selecting circuit 54 gives the transfer permission signal VCEa to the VCE 3.

Then, the remaining-slot-number calculating circuit 60 subtracts “1” from the reserved-slot-number “3” of the VCE 3 (the reserved-slot-number “3” stored in the renewed-slot register 31), sets the remaining slot-number to “2”, and overwrites the information into the renewed-slot register 31.

Next, at the second slot of the slot allotment period, only the PCE 5 gives the data transfer request signal PCEr (a signal of level “H (high)”) to the transfer-permissible-candidate determining circuit 70.

The transfer-permissible-candidate determining circuit 70 gives the transfer-permissible-candidate notifying signal P indicating that the transfer permissible candidate is the PCE 5 to the order-of-priority selecting circuit 54.

The order-of-priority selecting circuit 54 gives the transfer permission signal PCEa to the PCE 5.

Then, the remaining-slot-number calculating circuit 60 subtracts “1” from the reserved-slot-number “5” (the reserved-slot-number “5” stored in the renewed-slot register 30), sets the remaining slot-number to “4”, and writes the information into the renewed-slot register 30.

Next, at the third slot of the slot allotment period, the ACE 4, the CPU 2, and the PCE 5 give the data transfer request signal ACEr (a signal of level “H (high)”), the data transfer request signal CPUr (a signal of level “H (high)”), and the data transfer request signal PCEr (a signal of level “H (high)”) to the transfer-permissible-candidate determining circuit 70, respectively.

The transfer-permissible-candidate determining circuit 70 gives the transfer-permissible-candidates notifying signals A, C, and P indicating that the transfer permissible candidates are the ACE 4, the CPU 2, and the PCE 5 to the order-of-priority selecting circuit 54.

The order-of-priority selecting circuit 54 refers to the priority registers 52, 50, and 53, and gives the transfer permission signal ACEa to the ACE 4 that has the highest priority among the ACE 4, the CPU 2, and the PCE 5.

Then, the remaining-slot-number calculating circuit 60 subtracts “1” from the reserved-slot-number “2” (the reserved-slot-number “2” stored in the renewed-slot register 32) of the ACE 4, sets the remaining slot-number to “1”, and overwrites the information to the renewed-slot register 32.

Next, at the fourth slot of the slot allotment period, the CPU 2 and the PCE 5 give the data transfer request signal CPUr and the data transfer request signal PCEr to the transfer-permissible-candidate determining circuit 70, respectively.

The transfer-permissible-candidate determining circuit 70 gives the transfer-permissible-candidates notifying signals C and P indicating that transfer permissible candidates are the CPU 2 and the PCE 5 to the order-of-priority selecting circuit 54.

The order-of-priority selecting circuit 54 refers to the priority registers 50 and 53, and gives the transfer permission signal CPUa to the CPU 2 that has the higher priority between the CPU 2 and the PCE 5.

Then, the remaining-slot-number calculating circuit 60 subtracts “1” from the reserved-slot-number “4” (the reserved-slot-number “4” stored in the renewed-slot register 30) of the remaining reserved-slot-number, sets the remaining slot-number to “3”, and overwrites the information to the renewed-slot register 30.

As shown in the renewed-slot designating table of FIG. 4, the CPU 2 and the PCE 5 share the remaining reserved-slot-number stored in the remaining-reserved-slot register 20.

The countdown is executed up to the tenth slot of the slot allotment period and the renewed-slot registers 30-32 are reset after the countdown for the tenth slot is executed as mentioned above.

Here, the operation for the seventh slot of FIG. 6 is explained.

At the seventh slot of the slot allotment period, the ACE 4 and the VCE 3 give the data transfer request signal ACEr and the data transfer request signal VCEr to the transfer-permissible-candidate determining circuit 70, respectively.

The transfer-permissible-candidate determining circuit 70 gives the order-of-priority selecting circuit 54 the transfer-permissible-candidate notifying signal A indicating that the ACE 4 is the transfer permissible candidate, and the transfer-permissible-candidate notifying signal V indicating that the VCE 3 is the transfer permissible candidate.

The order-of-priority selecting circuit 54 refers to the priority registers 51 and 52, and gives the transfer permission signal ACEa to the ACE 4 that has the higher priority between the ACE 4 and the VCE 3.

Then, the remaining-slot-number calculating circuit 60 subtracts “1” from the reserved-slot-number “1” (the reserved-slot-number “1” stored in the renewed-slot register 32) of the reserved-slot-number for ACE 4, sets the remaining slot-number to “0”, and overwrites the information to the renewed-slot register 32.

The remaining-slot-number calculating circuit 60 notifies the CPU 2 via the interruption signal line 9 that the ACE 4 has used up the reserved-slot-number.

The flow of processing for the bus arbiter 1 shown in FIG. 1 is explained below, using FIG. 2 and a flow chart.

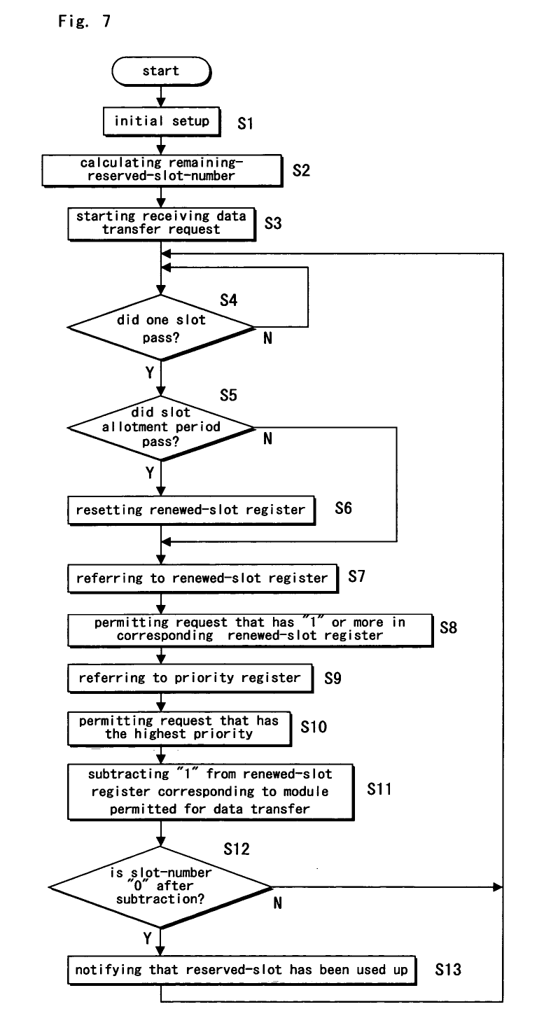

FIG. 7 is the flowchart, illustrating the operation of the bus arbiter 1.

As shown in FIG. 7, at Step S1, the CPU 2 performs an initial setting of the bus arbiter 1.

Specifically, the CPU 2 sets a slot allotment period to the slot allotment period register 10.

The CPU 2 sets a reserved-slot number of the VCE 3 to the reserved-slot register 21, and a reserved-slot number of the ACE 4 to the reserved-slot register 22, respectively.

The CPU 2 sets priority of the CPU 2, the VCE 3, the ACE 4, and the PCE 5 to the priority registers 50, 51, 52, and 53, respectively.

The CPU 2 sets a set of designating information each for the CPU 2, the VCE 3, the ACE 4, and the PCE 5 to the renewed-slot designating registers 40, 41, 42, and 43, respectively.

At Step S2, with reference to the slot allotment period register 10 and the reserved-slot registers 21 and 22, a remaining-slot-number calculating circuit 60 calculates the remaining reserved-slot number, and stores the calculated result in the remaining-reserved-slot register 20.

At Step S3, the bus arbiter 1 starts receiving a data transfer request. From this point, the bus arbiter 1 spends time in the slot allotment period.

At Step S7, the transfer-permissible-candidate determining circuit 70 refers to a renewed-slot register designated by the designating information stored in the renewed-slot designating register corresponding to a module that has outputted a data transfer request signal.

Each of the CPU 2, the VCE 3, the ACE 4, and the PCE 5 is called as a module in the present embodiment.

At Step S8, if the remaining slot number stored in the referred renewed-slot register is “1” or more, the transfer-permissible-candidate determining circuit 70 outputs a transfer-permissible-candidate notifying signal to the order-of-priority selecting circuit 54.

If plural modules have outputted the data transfer request signals, the processing at Step S7 or Step S8 is performed for each of the plural modules.

At Step S9, when a plurality of transfer-permissible-candidate notifying signals are inputted, the order-of-priority selecting circuit 54 refers to each priority register corresponding to each module designated by each transfer-permissible-candidate notifying signal.

At Step S10, the order-of-priority selecting circuit 54 outputs a transfer permission signal to a module having the highest priority among plural priorities stored in the plural referred priority registers.

Moreover, the order-of-priority selecting circuit 54 refers to the renewed-slot designating register corresponding to the module to which the transfer permission signal has been outputted, and gives the remaining-slot-number calculating circuit 60 the designating information (information on a renewed-slot register) stored in the referred renewed-slot designating register.

At Step S11, the remaining-slot-number calculating circuit 60 subtracts “1” from the number of slots stored in the renewed-slot register that the given designating information designates.

When the number of slots after the subtraction is not “0” (Step S12), and when one slot passes (Step S4), and when the slot allotment period does not pass (Step S5), the processing goes to Step S7.

When the number of slots after the subtraction is not “0” (Step S12), and when one slot passes (Step S4), and when the slot allotment period passes (Step S5), the remaining-slot-number calculating circuit 60 resets the renewed-slot registers 30 to 32 at Step S6. Then, the processing goes to Step S7.

When the number of slots after the subtraction is “0” (Step S12), at Step S13, the remaining-slot-number calculating circuit 60 notifies the CPU 2 via the interruption-signal line 9 that a module, to which the transfer permission signal has been given, has used up the reserved slot number. Then, the processing goes to Step S4.

A series of processing at Step S4 to Step S13, as described above, are performed repeatedly.

As described above, according to the present embodiment, it becomes possible to judge beforehand whether the processing by a module that is going to be performed will fail or not due to the shortage of the bus slot number (in other word, a bus bandwidth), by externally monitoring the remaining reserved-slot number that the remaining-reserved-slot register 20 stores.

The slot allotment period can be changed by externally changing a setup of the slot allotment period register 10. The reserved-slot-number can be changed by externally changing a setup of the reserved-slot registers 21 and 22. Consequently, improvement in user's convenience can be promoted.

When a module consumes all the reserved-slot numbers assigned to the module concerned, the CPU 2 is notified that all reserved-slot numbers have been consumed. Accordingly, useless data transfer request is prevented.

The effect of the present embodiment is explained describing a detailed example. The example assumes that a priority table is one that is illustrated in FIG. 5 and a renewed-slot designating table is one that is illustrated in FIG. 4.

The number of slots “340” is set as a slot allotment period in the slot allotment period register 10 shown in FIG. 2.

The number of slots “70” is set as a reserved-slot number of the VCE 3 in the reserved-slot register 21.

The number of slots “70” is set as a reserved-slot number of the ACE 4 in the reserved-slot register 22.

Therefore, the number of slots “200” is set as a remaining reserved-slot number in the remaining-reserved-slot register 20 (the remaining reserved-slot number is used by the CPU 2 and the PCE 5).

Here, the reserved-slot number of the VCE 3, i.e., the number of slots set in the reserved-slot register 21, is assumed to be the number of slots that can perform compression/expansion processing by the MPEG-4 for an image of the QCIF (176 pixels×144 pixels) size.

Therefore, “280” is needed as the number of slots required in the compression/expansion processing of a CIF-sized image.

In such a case, according to the present embodiment, it can be calculated in advance that the number of slots required in the compression/expansion processing of the CIF-sized image is not secured, when the image size of the compression/expansion processing by the MPEG-4 is extended from the QCIF to the CIF.

The reason is because the addition of the remaining-reserved-slot number “200” of the remaining-reserved-slot register 20 and the reserved-slot number “70” secured for the VCE 3 does not fill the number of slots “280” required for the compression/expansion processing of the CIF-sized image.

Therefore, when a request of extending the size of the image to be processed to a CIF size is issued, it becomes possible to cancel the request in advance.

Another effect of the present embodiment is explained by describing another detailed example.

When controlling bit rate change, the rate control program of the MPEG-4 operating in the CPU 2 can judge in advance whether the number of slots required after the bit rate change can be guaranteed, by referring to the remaining-reserved-slot register 20.

Furthermore, the other effect of the present embodiment is explained by referring to a detailed example.

The time (period) required for the compression/expansion processing differs between the MPEG-4 and the AMR.

Therefore, it becomes possible to set up the reserved-slot number appropriately, depending on the processing when the compression/expansion of the MPEG-4 is performed using the VCE 3, or the processing when the compression/expansion of the AMR is performed using the ACE 4.

The kinds and the number of the modules are not limited to these illustrated in FIG. 1.

In FIG. 2, the number of the reserved-slot registers 21 and 22 is not limited to two. The number of the reserved-slot register may be one, or may be three or more, according to the application.

The renewed-slot registers 31 and 32 are not limited to two in number, either. The number of the renewed-slot register corresponding to the number of the reserved-slots register may be provided.

The renewed-slot designating registers 40 to 43 are not limited to four in number. The number of the renewed-slot designating register corresponding to the number of the module may be provided.

The designating information set in the renewed-slot designating register is not limited to what is described in the present embodiment, but can be set up arbitrarily.

The priority registers 50 to 53 are not limited to four in number. The number of the priority register corresponding to the number of the module may be provided.

The priority set in the priority register is not limited to what is described in the present embodiment, but can be set up arbitrarily.

### EMBODIMENT 2

In the first embodiment, a plurality of data transfer requests from a plurality of modules are arbitrated. In the second embodiment, a plurality of data transfer requests from a task manager which manages a plurality of tasks are arbitrated.

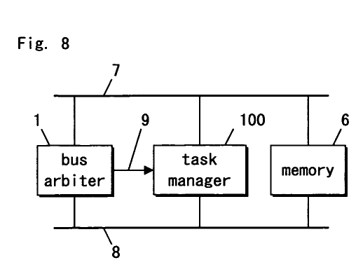

FIG. 8 is a block diagram of a data processing equipment in the second embodiment of the present invention. In FIG. 8, the same symbols are used to the same parts as FIG. 1.

As shown in FIG. 8, the data processing equipment according to the present embodiment has a bus arbiter 1, a task manager 100, and a memory 6.

The bus arbiter 1, the task manager 100, and the memory 6 are connected each other via a bus 8.

The bus arbiter 1, the task manager 100, and the memory 6 are also connected each other via a data transfer control line 7.

The task manager 100 is connected to the bus arbiter 1 by an interruption signal line 9 from the bus arbiter 1.

The task manager 100 manages a single task or plural tasks.

The task manager 100 may be software which operates on the CPU, may be hardware which can control the task working on the CPU, or may be a task control mechanism which combines the software and the hardware.

The bus arbiter 1 is an apparatus which assigns a data transfer request per slot to each task in response to the data transfer request from the task manager 100.

Moreover, the bus arbiter 1 has a mechanism to reserve the number of slots to each task, and a mechanism to monitor the remaining slot number which can be reserved.

The bus arbiter 1 assumes that one slot is a predetermined bus cycle number (a predetermined bus clock number).

The memory 6 stores data. When a task that the task manager 100 manages is executed, the data stored in the memory 6 is processed, and the processed result is restored in the memory 6.

The data processing equipment having the construction as shown in FIG. 8 performs plural tasks. The bus arbiter 1 allots a necessary number of slots for a real-time processing to a task that requires a real-time processing.

The construction of the bus arbiter 1 shown in FIG. 8 is the same as the construction of the bus arbiter 1 shown in FIG. 1. Therefore, the details of the bus arbiter 1 shown in FIG. 8 are explained using FIG. 2.

The following explanation describes a case where the task manager 100 manages four tasks, a task 1 to a task 4.

Assume that the task 2 and the task 3 are tasks which require a real-time processing.

The slot allotment period register 10 is a register which stores information indicating the slot allotment period specified in terms of the predetermined number of slots.

The slot allotment period for the slot allotment period register 10 can be set externally. For example, the task manager 100 can set the slot allotment period to the slot allotment period register 10.

A predetermined slot-number is beforehand allotted to each of the task 2 and the task 3, which perform real-time processing. In this case, the number of slots allotted beforehand is called a reserved-slot-number.

The reserved-slot register 21 stores information indicating the reserved-slot-number allotted to task 2.

The reserved-slot-number of the task 2 for the reserved-slot register 21 can be set externally. For example, the task manager 100 can set the reserved-slot-number of the task 2 to the reserved-slot register 21.

The reserved-slot register 22 stores information indicating the reserved-slot-number allotted to the task 3.

The reserved-slot-number of the task 3 for the reserved-slot register 22 can be set externally. For example, the task manager 100 can set the reserved-slot-number of the task 3 to the reserved-slot register 22.

The remaining-reserved-slot register 20 stores information indicating a value obtained by subtracting the reserved-slot-number stored in the reserved-slot register 21 and the reserved-slot-number stored in the reserved-slot register 22 from the slot-number that composes the slot allotment period. The value is hereinafter called a “remaining reserved-slot-number”.

The remaining reserved-slot-number is used by the task 1 and the task 4.

The reserved-slots registers 21 and 22 and the remaining-reserved-slot register 20 constitute a reservation slot table.

An example of the reservation slot table is shown in FIG. 3.

The remaining-slot-number calculating circuit 60 calculates a remaining reserved-slot-number by subtracting the reserved-slot-number stored in the reserved-slot register 21 and the reserved-slot-number stored in the reserved-slot register 22 from the number of slots that composes the slot allotment period.

The remaining reserved-slot-number stored in the remaining-reserved-slot register 20 is calculated by the remaining-slot-number calculating circuit 60.

The renewed-slot register 31 stores, as the initial value (reset value), information which indicates the reserved-slot-number of the task 2 stored in the reserved-slot register 21.

When the data transfer request of the task 2 is permitted, the remaining-slot-number calculating circuit 60 calculates the remaining-slot-number of the reserved-slot number by subtracting one slot from the reserved-slot-number that is allotted to the task 2, the reserved-slot-number being stored in the renewed-slot register 31.

The remaining-slot-number calculating circuit 60 overwrites information indicating the remaining-slot-number into the renewed-slot register 31.

Furthermore, every time when the data transfer request of the task 2 is permitted, the remaining-slot-number calculating circuit 60 calculates the remaining-slot-number of the reserved-slot number for the task 2 by subtracting one slot from the remaining-slot-number of the reserved-slot-number that is stored in the renewed-slot-register 31. The remaining-slot-number calculating circuit 60 overwrites the calculated result into the renewed-slot register 31.

In this manner, the reserved-slot-number of the task 2 is counted down.

The renewed-slot register 32 stores, as the initial value (reset value), information which indicates the reserved-slot-number of the task 3 stored in the reserved-slot register 22.

When the data transfer request of the task 3 is permitted, the remaining-slot-number calculating circuit 60 calculates the remaining-slot-number of the reserved-slot number by subtracting one slot from the reserved-slot-number that is allotted to the task 3 stored in the renewed-slot register 32.

The remaining-slot-number calculating circuit 60 overwrites information indicating the remaining-slot-number into the renewed-slot register 32.

Furthermore, every time when the data transfer request of the task 3 is permitted, the remaining-slot-number calculating circuit 60 calculates the remaining-slot-number of the reserved-slot number for the task 3 by subtracting one slot from the remaining-slot-number of the reserved-slot-number that is stored in the renewed-slot register 32. The remaining-slot-number calculating circuit 60 overwrites the calculated result into the renewed-slot register 32.

In this manner, the reserved-slot-number of the task 3 is counted down.

The renewed-slot register 30 stores, as the initial value (reset value), information which indicates the remaining reserved-slot-number stored in the remaining-reserved-slot register 20.

When the data transfer request of the task 1 or the task 4 is permitted, the remaining-slot-number calculating circuit 60 calculates the remaining-slot-number of the remaining reserved-slot number by subtracting one slot from the remaining reserved-slot-number that is stored in the renewed-slot register 30.

The remaining-slot-number calculating circuit 60 overwrites information indicating the remaining-slot-number into the renewed-slot register 30.

Furthermore, every time when the data transfer request of the task 1 or the task 4 is permitted, the remaining-slot-number calculating circuit 60 calculates the remaining-slot-number of the remaining reserved-slot number by subtracting one slot from the remaining-slot-number of the remaining reserved-slot-number that is stored in the renewed-slot register 30. The remaining-slot-number calculating circuit 60 overwrites the calculated result into the renewed-slot register 30.

In this manner, the remaining reserved-slot-number is counted down.

When the slot allotment period, which is designated by the slot allotment period register 10, has passed, the renewed-slot registers 30, 31, and 32 are reset.

In other words, when the slot allotment period, which is specified by the slot allotment period register 10, has passes, the remaining-slot-number calculating circuit 60 writes, as the initial value (reset value), information indicating the reserved-slot-number stored in the reserved-slot register 21 into the renewed-slot register 31. The remaining-slot-number calculating circuit 60 also writes, as the initial value (reset value), information indicating the reserved-slot-number stored in the reserved-slot register 22 to the renewed-slot register 32. The remaining-slot-number calculating circuit 60 also writes, as the initial value (reset value), information indicating the remaining reserved-slot-number stored in the remaining-reserved-slot register 20 into the renewed-slot register 30.

Then, the countdown of the reserved-slot-number and the remaining reserved-slot-number is executed again.

Thus, reset and countdown are performed repeatedly. When the slot allotment period passes, reset will be performed even when the countdown value is not “0”.

Designating information for the task 1, designating information for the task 2, designating information for the task 3, and designating information for the task 4 are stored in the renewed-slot designating registers 40, 41, 42, and 43, respectively.

The designating information is information designating the renewed-slot register 31, information designating the renewed-slot register 32 or information designating the renewed-slot register 30.

Specifically, the information designating the renewed-slot register 30 is stored in the renewed-slot designating register 40 as the designating information for the task 1, because the task 1 consumes the remaining reserved-slot-number stored in the remaining-reserved-slot register 20.

The information designating the renewed-slot register 31 is stored in the renewed-slot designating register 41 as the designating information for the task 2, because the task 2 consumes the reserved-slot-number stored in the reserved-slot register 21.

The information designating the renewed-slot register 32 is stored in the renewed-slot designating register 42 as the designating information for the task 3, because the task 3 consumes the reserved-slot-number stored in the renewed-slot designating register 43.

The information designating the renewed-slot register 30 is stored in the renewed-slot designating register 43 as the designating information for the task 4, because the task 4 consumes the remaining reserved-slot-number stored in the remaining-reserved-slot register 20.

The designating information of the renewed-slot designating registers 40-43 can be set up externally, for example by the task manager 100.

When initial setting of the bus arbiter 1 is performed, information designating the renewed-slot register 30 is stored in all of the renewed-slot designating registers 40-43. Then, information designating the renewed-slot registers 31 and 32 is overwritten externally to the desired renewed-slot designating register.

An example of the renewed-slot designating table is one shown in FIG. 4, assuming that the renewed-slot designating register 40 is for the tasks 1, the renewed-slot designating register 41 is for the tasks 2, the renewed-slot designating register 42 is for the tasks 3, and the renewed-slot designating register 43 is for the tasks 4.

In addition, in the example of FIG. 4, the task 1 and the task 4 share the renewed-slot register 30.

Via the data transfer control line 7, the transfer-permissible-candidate determining circuit 70 receives, from the task manager 100, a data transfer request signal CPUr for the task 1, a data transfer request signal VCEr for the task 2, a data transfer request signal ACEr for the task 3, and a data transfer request signal PCEr for the task 4.

When the transfer-permissible-candidate determining circuit 70 receives the data transfer request signal CPUr for the task 1, the transfer-permissible-candidate determining circuit 70 refers to the renewed-slot designating register 40 corresponding to the task 1.

Then, the transfer-permissible-candidate determining circuit 70 refers to the renewed-slot register 30 that is designated by the information stored in the renewed-slot designating register 40.

When the remaining slot-number (countdown value) of the remaining reserved-slot-number stored in the renewed-slot register 30 is not “0” the transfer-permissible-candidate determining circuit 70 outputs to the order-of-priority selecting circuit 54 a transfer-permissible-candidate notifying signal C, which indicates that the task 1 is a candidate to be permitted for the data transfer (a transfer permissible candidate).

When the transfer-permissible-candidate determining circuit 70 receives the data transfer request signal VCEr for the task 2, the transfer-permissible-candidate determining circuit 70 refers to the renewed-slot designating register 41 corresponding to the task 2.

Then, the transfer-permissible-candidate determining circuit 70 refers to the renewed-slot register 31 that is designated by the information stored in the renewed-slot designating register 41.

When the remaining slot-number (countdown value) of the reserved-slot-number stored in the renewed-slot register 31 is not “0”, the transfer-permissible-candidate determining circuit 70 outputs to the order-of-priority selecting circuit 54 a transfer-permissible-candidate notifying signal V, which indicates that the task 2 is a candidate to be permitted for the data transfer (a transfer permissible candidate).

When the transfer-permissible-candidate determining circuit 70 receives the data transfer request signal ACEr for the task 3, the transfer-permissible-candidate determining circuit 70 refers to the renewed-slot designating register 42 corresponding to the task 3.

Then, the transfer-permissible-candidate determining circuit 70 refers to the renewed-slot register 33 that is designated by the information stored in the renewed-slot designating register 42.

When the remaining slot-number (countdown value) of the reserved-slot-number stored in the renewed-slot register 32 is not “0”, the transfer-permissible-candidate determining circuit 70 outputs to the order-of-priority selecting circuit 54 a transfer-permissible-candidate notifying signal A, which indicates that the task 3 is a candidate to be permitted for the data transfer (a transfer permissible candidate).

When the transfer-permissible-candidate determining circuit 70 receives the data transfer request signal PCEr for the task 4, the transfer-permissible-candidate determining circuit 70 refers to the renewed-slot designating register 43 corresponding to the task 4.

Then, the transfer-permissible-candidate determining circuit 70 refers to the renewed-slot register 30 that is designated by the information stored in the renewed-slot designating register 43.

When the remaining slot-number (countdown value) of the reserved-slot-number stored in the renewed-slot register 30 is not “0”, the transfer-permissible-candidate determining circuit 70 outputs to the order-of-priority selecting circuit 54 a transfer-permissible-candidate notifying signal P, which indicates that the task 4 is a candidate to be permitted for the data transfer (a transfer permissible candidate).

Information indicating the priority of the task 1 is stored in the priority register 50. Information indicating the priority of the task 2 is stored in the priority register 51. Information indicating the priority of the task 3 is stored in the priority register 52. Information indicating the priority of the task 4 is stored in the priority register 53.

The priority can be set externally into the priority registers 50-53. For example, the task manager 100 can set the priority into the priority registers 50-53.

The priority registers 50-53 compose a priority table.

FIG. 5 is an explanatory diagram, illustrating the priority table.

An example of the priority table is one shown in FIG. 5, assuming that the priority register 50 is for the task 1, the priority register 51 is for task 2, the priority register 52 is for task 3, and the priority register 53 is for task 4.

In a case where plural pieces of the transfer-permissible-candidate notifying signals are inputted from the transfer-permissible-candidate determining circuit 70, that is a case where plural tasks are permitted as transfer permissible candidates, the order-of-priority selecting circuit 54 refers to the priority registers 50-53, and gives a transfer permission signal via the data transfer control line 7 to a transfer permissible candidate whose priority is highest among the plural transfer permissible candidates.

Specifically, the order-of-priority selecting circuit 54 outputs, to the task manager 100 via the data transfer control line 7, a transfer permission signal which indicates a transfer permissible candidate to which transfer permission is to be given.

In FIG. 2, a transfer permission signal CPUa indicates a transfer permission signal to the task 1, a transfer permission signal VCEa indicates a transfer permission signal to the task 3, and a transfer permission signal PCEa indicates a transfer permission signal to the task 4.

For example, in a case of the priority table as shown in FIG. 5, when the order-of-priority selecting circuit 54 receives the transfer-permissible-candidate notifying signal C for the task 1 and the transfer-permissible-candidate notifying signal V for the task 2, the order-of-priority selecting circuit 54 outputs to the task manager 100 the transfer permission signal VCEa, indicating to give transfer permission to the task 2, which possesses the higher priority.

On the other hand, the order-of-priority selecting circuit 54 refers to the renewed-slot designating register corresponding to the transfer permissible candidate that is already given the transfer permission signal.

Then, the order-of-priority selecting circuit 54 gives the remaining-slot-number calculating circuit 60 the information stored in the referred renewed-slot designating register.

The remaining-slot-number calculating circuit 60 selects one of the renewed-slot register 31, the renewed-slot register 32, and the renewed-slot register 30, based on the information that is given by the order-of-priority selecting circuit 54, and subtracts one slot from the remaining slot-number that is stored in the selected register.

The remaining-slot-number calculating circuit 60 overwrites information indicating the remaining slot-number, which has been calculated in the above-mentioned way, to one of the renewed-slot register 31, the renewed-slot register 32, and the renewed-slot register 30, based on the information that has been given by the order-of-priority selecting circuit 54.

Every time when transfer permission is given, the reserved-slot-number or the remaining reserved-slot-number of the transfer permissible candidate that is given the transfer permission is counted down.

It will be explained by exemplifying a case where the task 3 is the transfer permissible candidate to which the transfer permission has been given.

The order-of-priority selecting circuit 54 refers to the renewed-slot designating register 42 corresponding to the task 3.

Then, the order-of-priority selecting circuit 54 gives the information stored in the renewed-slot designating register 42 or the information indicating the renewed-slot register 32, to the remaining-slot-number calculating circuit 60.

The remaining-slot-number calculating circuit 60 subtracts one slot from the remaining slot-number of the reserved-slot-number for the task 3, the remaining slot-number being stored in a renewed-slot register designated by the information that is given by the order-of-priority selecting circuit 54.

The remaining-slot-number calculating circuit 60 overwrites information indicating the remaining slot-number of the task 3, which has been calculated in the above-mentioned way, to the renewed-slot register 32 designated by the information that is given by the order-of-priority selecting circuit 54.

In this example, the reserved-slot-number of the task 3 is counted down in the above-mentioned way.

When the remaining slot-number of the reserved-slot-number becomes null as a result of the countdown (as a result of subtraction) or when the remaining slot-number of the remaining reserved-slot-number becomes null, the remaining-slot-number calculating circuit 60 notifies the task manager 100 via the interruption signal line 9 that the task, which uses the reserved-slot-number or the remaining reserved-slot-number with a null remaining slot-number, has used up the reserved-slot-number or the remaining reserved-slot-number.

After receiving the notice, the task manager 100 assigns a task as the scheduling target, the task having a number more than “1” as the number of slots, stored in the renewed-slot registers 30-32.

It is assumed that the reservation slot table includes the remaining-reserved-slot register 20 and the reserved-slot registers 21 and 22 as shown in FIG. 2, and is set up as shown in FIG. 3. It is also assumed that the renewed-slot designating table includes the renewed-slot designating registers 40-43 as shown in FIG. 2, and is set up as shown in FIG. 4. It is further assumed that the priority table includes the priority registers 50-53 as shown in FIG. 2, and is set up as shown in FIG. 5.

In this case, the time chart for the bus arbiter 1 according to the present embodiment is the same as shown in FIG. 6. However, in the present embodiment, the bus arbiter 1 arbitrates each data transfer request of each task.

The flow of the processing for the bus arbiter 1 according to the present embodiment is the same as that shown in the flowchart of FIG. 7. However, in the present embodiment, the bus arbiter 1 arbitrates each data transfer request of each task.

In order that the tasks 1 and 4, whose reserved-slot-numbers are not set beforehand, can use the remaining reserved-slot-number, the task manager 100 sets, as mentioned above, the designating information designating the renewed-slot register 30 to the renewed-slot designating registers 40 and 43, each corresponding to the tasks 1 and 4.

Therefore, when the tasks 1 and 4, whose reserved-slot-numbers are not set beforehand, have used up the remaining reserved-slot-number, the bus arbiter 1 issues interruption to the task manager 100 via the interruption signal line 9. The interruption indicates that the remaining reserved-slot-number is used up.

The task manager 100, in receipt of the above-mentioned interruption, hands over the right of execution to the tasks 2 and 3, thus guaranteeing the slot number for the tasks 2 and 3 to which the reserved-slot-numbers are set beforehand.

As described above, according to the present embodiment, it becomes possible to judge beforehand whether the processing by a task that is going to perform will fail or not due to the shortage of the bus slot number (in other word, a bus bandwidth), by externally monitoring the remaining reserved-slot number that the remaining-reserved-slot register 20 stores.

A slot allotment period can be changed by externally changing a setup of the slot allotment period register 10. A reserved-slot-number can be changed by externally changing a setup of the reserved-slot registers 21 and 22. Consequently, improvement in user's convenience can be promoted.

When a task consumes all the reserved-slot numbers assigned to the task concerned, the task manager 100 is notified that all reserved-slot numbers have been consumed. Accordingly, useless data transfer request is prevented.

The types of tasks are not limited to the tasks 14 mentioned above.

In FIG. 2, the number of the reserved-slot registers 21 and 22 is not limited to two. The number of the reserved-slot register may be one, or may be three or more.

The renewed-slot registers 31 and 32 are not limited to two in number, either. The number of the renewed-slot register corresponding to the number of the reserved-slots register may be provided.

The renewed-slot designating registers 40-43 are not limited to four in number. The number of the renewed-slot designating register corresponding to the number of tasks may be provided.

The designating information set in the renewed-slot designating register is not limited to what is described in the present embodiment, but can be set up arbitrarily.

The priority registers 50-53 are not limited to four in number. The number of the priority register corresponding to the number of tasks may be provided.

The priority set in the priority register is not limited to what is described in the present embodiment, but can be set up arbitrarily.

A modified example of the second embodiment of the present invention is explained in the following.

The modified example is the combination of the first embodiment and the second embodiment.

Namely, the bus arbiter according to the modified example arbitrates data transfer requests from a plurality of modules and a plurality of tasks.

An example of the bus arbiter according to the modified example is explained. In this example, each reserved-slot register for each task and each reserved-slot register for each module are provided in the bus arbiter shown in FIG. 2.

Furthermore, each renewed-slot register is provided corresponding to each reserved-slot register for each task, and to each reserved-slot register for each module.

Each renewed-slot designating register is provided corresponding to each task and each module.

Furthermore, each priority register is provided corresponding to each task and each module.

In this case, assuming that the task manager 100 is software operating on the CPU 2, the whole construction of the data processing apparatus according to the modified example becomes the same as shown in FIG. 1.

On the other hand, assuming that the task manager 100 is hardware that can control the task on the CPU, and that the task manager 100 is a task control mechanism made of software and hardware, the entire construction of the data processing apparatus according to the modified example becomes one that the task manager 100 shown in FIG. 8 is added to the data processing apparatus shown in FIG. 1.

Another example of the bus arbiter according to the modified example is explained.

In this example, it is assumed that the task manager 100 is software operating on the CPU 2. Then, the entire composition of the data processing apparatus becomes the same as shown in FIG. 1.

Moreover, the bus arbiter according to the first embodiment of the present invention, as shown in FIG. 2, can be used as the construction of the bus arbiter.

In this example, the CPU 2 can be considered as the task manager 100. Therefore, the renewed-slot register to the task is set, as the designating information, in the renewed-slot designating register 40 corresponding to the CPU 2.

For example, the renewed-slot register 30 can be set up as the designating information. In this case, the task that the task manager 100 manages consumes the remaining reserved-slot-number stored in the remaining-reserved-slot register 20.

As another example, the renewed-slot register 31 can be set up as designating information. In this case, the task that the task manager 100 manages consumes the reserved-slot-number stored in the registered-slot register 21.

This example is described more specifically as follows.

In the system shown in FIGS. 1 and 2, in which the CPU 2 or the task manager 100 manages, it is assumed that the moving picture expansion processing is a process after the moving picture expansion processing by the VCE 3 up to a special effect process such as filtering image data, performed by a special-effect processing task executed on the CPU 2.

For this case, by providing the renewed-slot register 31 in both of the renewed-slot designating register 41 corresponding to the VCE 3 and the renewed-slot designating register 40 corresponding to the special-effect processing task, the slot number necessary for the moving picture expansion processing can be guaranteed. Here, the moving picture expansion processing consists of the processing of the VCE 3 and the processing of the special-effect processing task on the CPU 2.

Regarding the priority of the task, the priority stored in the priority register 50 corresponding to the CPU 2 is the priority of the task.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A bus arbiter operable to arbitrate data transfer requests among plural modules connected to a bus, the bus arbiter comprising:
a slot allotment period storing unit operable to store information of a slot allotment period including plural slots;
a reserved-slot-number storing unit operable to store information of a reserved slot number, the reserved slot number being a slot number previously allotted to a predetermined module of the plural modules;
a remaining-reserved-slot-number storing unit operable to store information of a remaining reserved slot number, the remaining reserved slot number being a difference between a total slot number constituting the slot allotment period and the reserved slot number;
a remaining-slot-number calculating unit operable to calculate a remaining slot number of the reserved slot number each time when a data transfer request is permitted for the predetermined module to which the reserved slot number is allotted, and operable to calculate a remaining slot number of the remaining reserved slot number each time when a data transfer request is permitted for the module that uses the remaining reserved slot number;
a first renewed-slot-number storing unit operable to store, as an initial value, information of the reserved slot number stored in said reserved-slot-number storing unit, and operable to store information of the remaining slot number of the reserved slot number, the remaining slot number being calculated by said remaining-slot-number calculating unit;
a second renewed-slot-number storing unit operable to store, as an initial value, information of the remaining reserved slot number stored in said remaining-reserved-slot-number storing unit, and operable to store information of the remaining slot number of the remaining reserved slot number, the remaining slot number being calculated by said remaining-slot-number calculating unit;
a plurality of renewed-slot-number-designating storing units operable to store information designating said first renewed-slot-number storing unit or said second renewed-slot-number storing unit, each thereof being installed corresponding to the plural modules and allotted to the corresponding module;
a transfer-permissible-candidate determining unit operable, in response to a request of data transfer from the module, to generate a transfer-permissible-candidate notifying signal indicating that the module is a candidate for which a data transfer request is permitted only when, referring to either said first renewed-slot-number storing unit or said second renewed-slot-number storing unit designated by the information stored in said renewed-slot-number-designating storing unit that corresponds to the module, a remaining slot number still remains, the remaining slot number being stored in either said first renewed-slot-number storing unit or said second renewed-slot-number storing unit that is referred; and
a transfer permission determining unit operable, according to a predetermined rule, to determine permission for the data transfer request from the module designated by the transfer-permissible-candidate notifying signal;
wherein information indicating said first renewed-slot-number storing unit is stored in said renewed-slot-number-designating storing unit corresponding to the predetermined module to which the reserved slot number is allotted,
wherein information indicating said second renewed-slot-number storing unit is stored in said renewed-slot-number-designating storing unit corresponding to the predetermined module that uses the remaining reserved slot number;
wherein information of the reserved slot number stored in said reserved-slot-number storing unit is stored, as an initial value, into said first renewed-slot-number storing unit each time when the slot allotment period elapses; and
wherein information of the remaining reserved slot number stored in said remaining-reserved-slot-number storing unit is stored, as an initial value, into said second renewed-slot-number storing unit each time when the slot allotment period elapses.

2. A bus arbiter as defined in claim 1, wherein
plural pieces of the predetermined module are connected to the bus;
plural pieces of said reserved-slot-number storing unit are provided corresponding to the plural pieces of the predetermined module; and
plural pieces of said first renewed-slot-number storing unit are provided corresponding to the plural pieces of said reserved-slot-number storing unit.

3. A bus arbiter as defined in claim 1, wherein, when the remaining slot number of the reserved slot number is exhausted, said remaining-slot-number calculating unit notifies a manager-assigned module of the plural modules that the predetermined module, to which the reserved slot number is allotted, has spent all the reserved slot number.

4. A bus arbiter operable to arbitrate data transfer requests among plural modules connected to a bus, the bus arbiter comprising a remaining-reserved-slot-number storing unit operable to store information of a remaining reserved slot number, the remaining reserved slot number being a difference between a slot number of a slot allotment period including plural slots and a reserved slot number, the reserved slot number being a slot number previously allotted to a predetermined module of the plural modules.

5. A bus arbiter as defined in claim 4, further comprising a slot allotment period storing unit operable to store information of the slot allotment period.

6. A bus arbiter as defined in claim 4, further comprising a reserved-slot-number storing unit operable to store information of the reserved slot number.

7. A bus arbiter as defined in claims 4, wherein, when the predetermined module has spent all the reserved slot number, a manager-assigned module of the plural modules is notified that all the reserved slot number is spent.

8. A bus arbiter as defined in claims 4, wherein plural pieces of the predetermined module are provided, and said remaining-reserved-slot-number storing unit stores information of a remaining reserved slot number, the remaining reserved slot number being a difference between the slot number constituting the slot allotment period and a sum of plural pieces of the reserved slot number.

9. A bus arbiter operable to arbitrate data transfer requests among plural tasks managed by a task manager connected to a bus, the bus arbiter comprising:
a slot allotment period storing unit operable to store information of a slot allotment period including plural slots;
a reserved-slot-number storing unit operable to store information of a reserved slot number, the reserved slot number being a slot number previously allotted to a predetermined task of the plural tasks;
a remaining-reserved-slot-number storing unit operable to store information of a remaining reserved slot number, the remaining reserved slot number being a difference between a total slot number constituting the slot allotment period and the reserved slot number;
a remaining-slot-number calculating unit operable to calculate a remaining slot number of the reserved slot number each time when a data transfer request is permitted for the predetermined task to which the reserved slot number is allotted, and operable to calculate a remaining slot number of the remaining reserved slot number each time when a data transfer request is permitted for the task that uses the remaining reserved slot number;
a first renewed-slot-number storing unit operable to store, as an initial value, information of the reserved slot number stored in said reserved-slot-number storing unit, and operable to store information of the remaining slot number of the reserved slot number, the remaining slot number being calculated by said remaining-slot-number calculating unit;
a second renewed-slot-number storing unit operable to store, as an initial value, information of the remaining reserved slot number stored in said remaining-reserved-slot-number storing unit, and operable to store information of the remaining slot number of the remaining reserved slot number, the remaining slot number being calculated by said remaining-slot-number calculating unit;
a plurality of renewed-slot-number-designating storing units operable to store information designating said first renewed-slot-number storing unit or said second renewed-slot-number storing unit, each thereof being installed corresponding to the plural tasks and allotted to the corresponding task;
a transfer-permissible-candidate determining unit operable, in response to a request of data transfer from the task, to generate a transfer-permissible-candidate notifying signal indicating that the task is a candidate for which a data transfer request is permitted only when, referring to either said first renewed-slot-number storing unit or said second renewed-slot-number storing unit designated by the information stored in said renewed-slot-number-designating storing unit that corresponds to the task, a remaining slot number still remains, the remaining slot number being stored in either said first renewed-slot-number storing unit or said second renewed-slot-number storing unit that is referred; and
a transfer permission determining unit operable, according to a predetermined rule, to determine permission for the data transfer request from the module designated by the transfer-permissible-candidate notifying signal;
wherein information indicating said first renewed-slot-number storing unit is stored in said renewed-slot-number-designating storing unit corresponding to the predetermined task to which the reserved slot number is allotted,
wherein information indicating said second renewed-slot-number storing unit is stored in said renewed-slot-number-designating storing unit corresponding to the predetermined task that uses the remaining reserved slot number;
wherein information of the reserved slot number stored in said reserved-slot-number storing unit is stored, as an initial value, into said first renewed-slot-number storing unit each time when the slot allotment period elapses; and
wherein information of the remaining reserved slot number stored in said remaining-reserved-slot-number storing unit is stored, as an initial value, into said second renewed-slot-number storing unit each time when the slot allotment period elapses.

10. A bus arbiter as defined in claim 9, wherein
plural pieces of the predetermined task are present;
plural pieces of said reserved-slot-number storing unit are provided corresponding to the plural pieces of the predetermined task; and
plural pieces of said first renewed-slot-number storing unit are provided corresponding to the plural pieces of said reserved-slot-number storing unit.

11. A bus arbiter as defined in claim 9, wherein, when the remaining slot number of the reserved slot number is exhausted, said remaining-slot-number calculating unit notifies the task manager that the predetermined task, to which the reserved slot number is allotted, has spent all the reserved slot number.

12. A bus arbiter operable to arbitrate data transfer requests among plural tasks managed by a task manager connected to a bus, the bus arbiter comprising a remaining-reserved-slot-number storing unit operable to store information of a remaining reserved slot number, the remaining reserved slot number being a difference between a slot number of a slot allotment period including plural slots and a reserved slot number, the reserved slot number being a slot number previously allotted to a predetermined task of the plural tasks.

13. A bus arbiter as defined in claim 12, further comprising a slot allotment period storing unit operable to store information of the slot allotment period.

14. A bus arbiter as defined in claim 12, further comprising a reserved-slot-number storing unit operable to store information of the reserved slot number.

15. A bus arbiter as defined in claims 12, wherein, when the predetermined task has spent all the reserved slot number, the task manager is notified that all the reserved slot number is spent.

16. A bus arbiter as defined in claims 12, wherein plural pieces of the predetermined task are present, and said remaining-reserved-slot-number storing unit stores information of a remaining reserved slot number, the remaining reserved slot number being a difference between the slot number constituting the slot allotment period and a sum of plural pieces of the reserved slot number.
